(19) United States
(12) Patent Application Publication
(10) Pub. No.: US 2007/0075303 A1
(43) Pub. Date: Apr. 5, 2007

(54) Assit-a-lift

(76) Inventors: Thomas R. Parks, Bakersfield, CA (US); Rita G. Parks, Bakersfield, CA (US)

Correspondence Address: THOMAS R. PARKS, 3808 WILCOX WAY, BAKERSFIELD, CA, 93309, US

(21) Appl. No.: 11/374,604

(22) Filed: Mar. 14, 2006

Related U.S. Application Data
(60) Provisional application No. 60/722,718, filed on Oct. 3, 2005.

(51) Int. Cl. B60S 9/02

(52) U.S. Cl. 254/418

(57) ABSTRACT

As briefly described in my CLAIM on page 29, my invention titled Assist-A-Lift, is the unique combination of my four separate custom-fabricated sub-assemblies herein described in this patent application that combine into a system that includes a pivot-type tongue hitch boat trailer. This trailer incorporates a fulcrum on the trailer located approximately 7 feet back from the original front 2 inch ball hitch that provides the necessary capability of the much-needed lever-effect luxury of clearance when backing uphill or on inclines where doorways are encountered. This is especially accommodating for persons with disability or handicapped individuals seeking this powered luxury tool and aid.

### BACKGROUND OF THE INVENTION

A modern and unique personal aid in the recreational field of transportation where powered and towed wheeled trailers of any type require a powered mechanical aid and luxury tool for raise and lower functions, unencumbered in its use.

Since time immemorial, laborious actions of one so susceptible of this type of recreational or desired action has had to subject themselves to a more labor-intensive task of completing these tasks for the same desired results.

### BRIEF SUMMARY OF THE INVENTION

Easy to install, connect and use

Passive until connected to tow vehicle for use

Powered by vehicle, no separate power source needed

Power Indication on remote Enclosure when connected and ready for use

Robust Quality in its custom manufacture

Innovative Application

No limited duty cycle constraints

Rated and built with ample reserve power capacity

Corrosion resistant, buffed cast aluminum remote enclosure

Corrosion resistant, buffed aluminum hand-held pilot control

No effort involved during use

Safe and deliberate functions required only during powered use

Remote enclosure resorts to stand-by status when not accessed

Operator must posses and hold defined spring return, center off, 2 position function switch in hand grip pilot control before desired raise and lower functions commence.

Power supply cord connects easily from either end of the ambidextrous connections on the power cord and cannot in any way be mis-aligned during mating of the plugs and receptacles. Cross-connecting or reverse polarity cannot be established or achieved in any way whatsoever, no matter the orientation of the plug connections on the power cord. This is due to the unique design and the NEMA plugs and receptacles used in this custom application. (NEMA: National Electrical Manufacturers Association).

### BRIEF DESCRIPTION OF THE SEVERALS VIEWS OF THE INVENTION

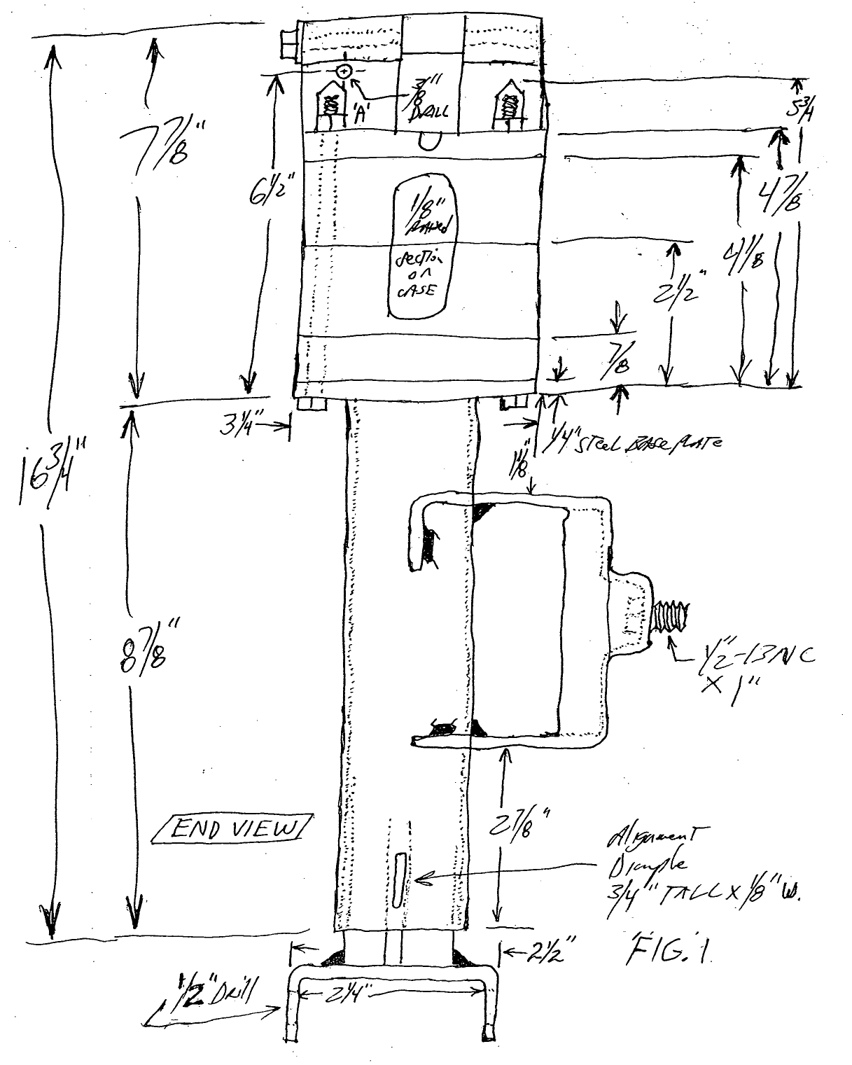

FIG. 1: Front side Drawing of 12 Volt D.C Electric Reversing Screw Jack

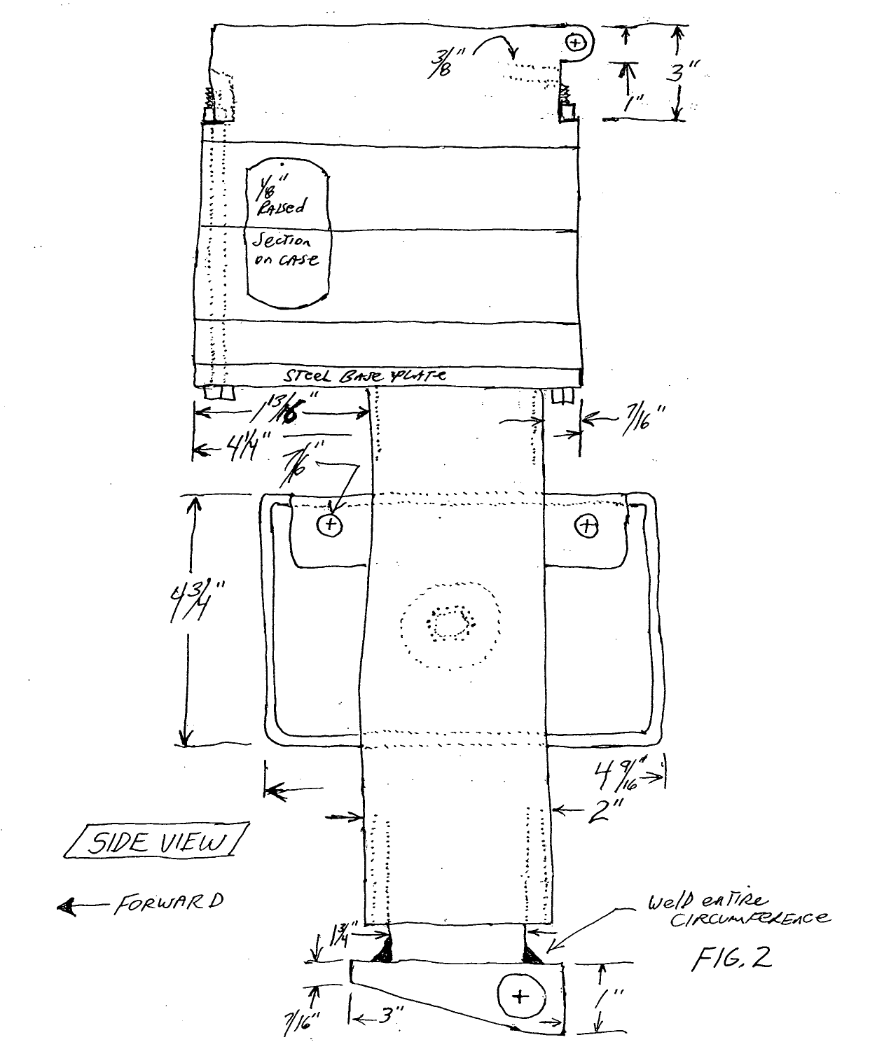

FIG. 2: Side view Drawing of 12 Volt D.C. Electric Reversing Screw Jack

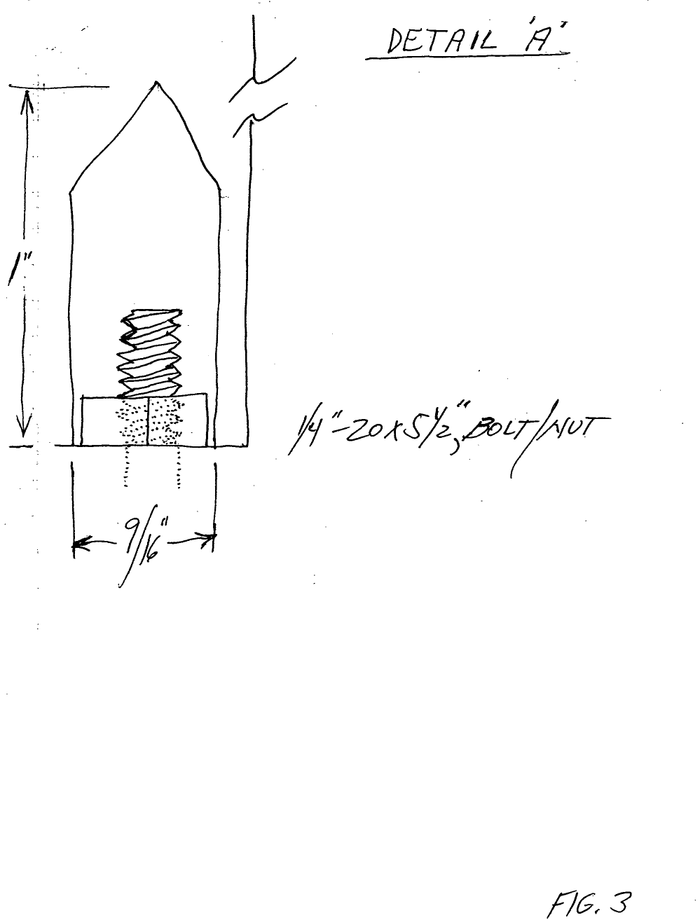

FIG. 3: Detail “A”, Relief, 12 Volt D.C. Electric Reversing Screw Jack, cover/Bonnet Cap for ¼″-20×5½″ thru-bolt/nut relief, typical, quanity four(4).

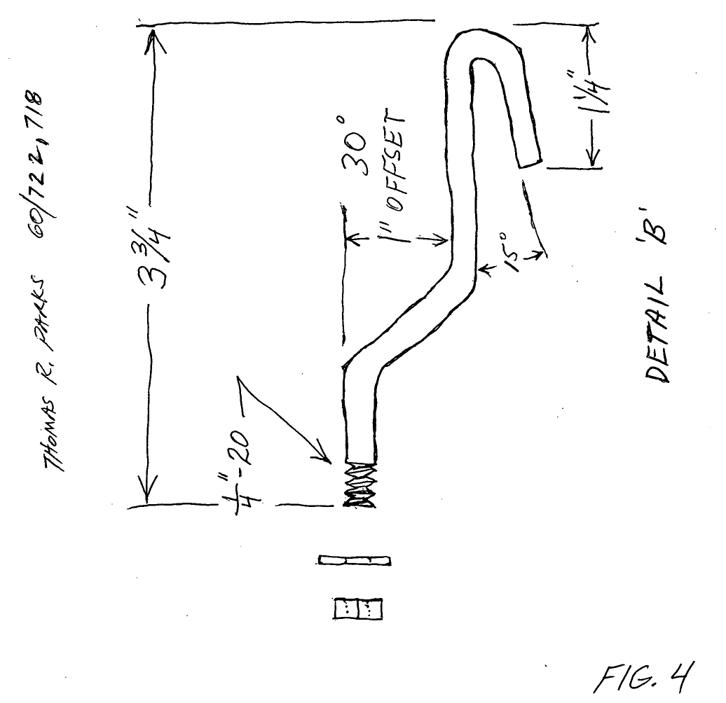

FIG. 4: Detail “B”, Enclosure Threaded Mount, ¼″ Stainless Steel Round Stock, Quanity Two, Custom Hand Fabricated, Non-Mandrel Bent, Polished and Muslin Power Buffed. NOTE: These two custom hand-fabricated mounts replace the temporary nylon straps shown in photograph #'s 1,3 &7 and are a permanently fixed securing anchors for same.

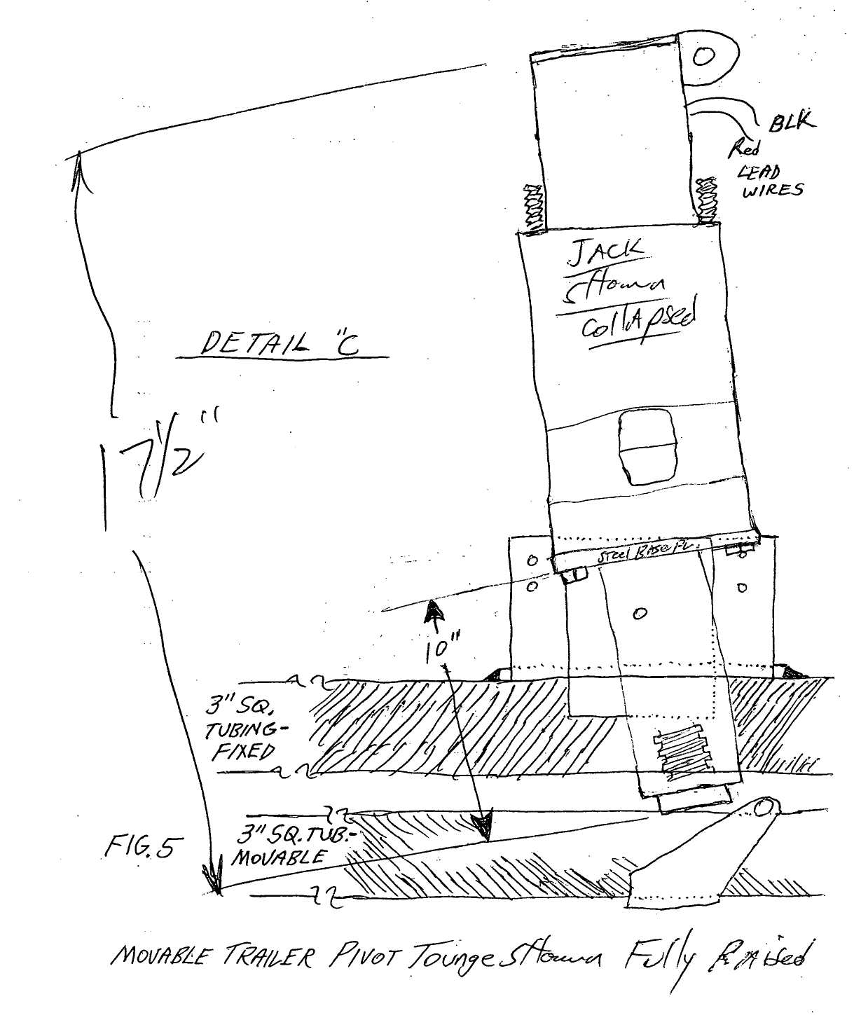

FIG. 5: Detail “C”, Sketch, for reference Only, Electric Screw Jack, (OEM: (TBD)), Fixed and Movable 3 Inch Square Steel Trailer Pivot Tongue Tubing Shown, (see photograph # 7 & 8 for clarity). NOTE: ¾″ square threaded brass lead screw partially shown in this detail is exploited as non-hidden view, with 6¼″ travel capability.

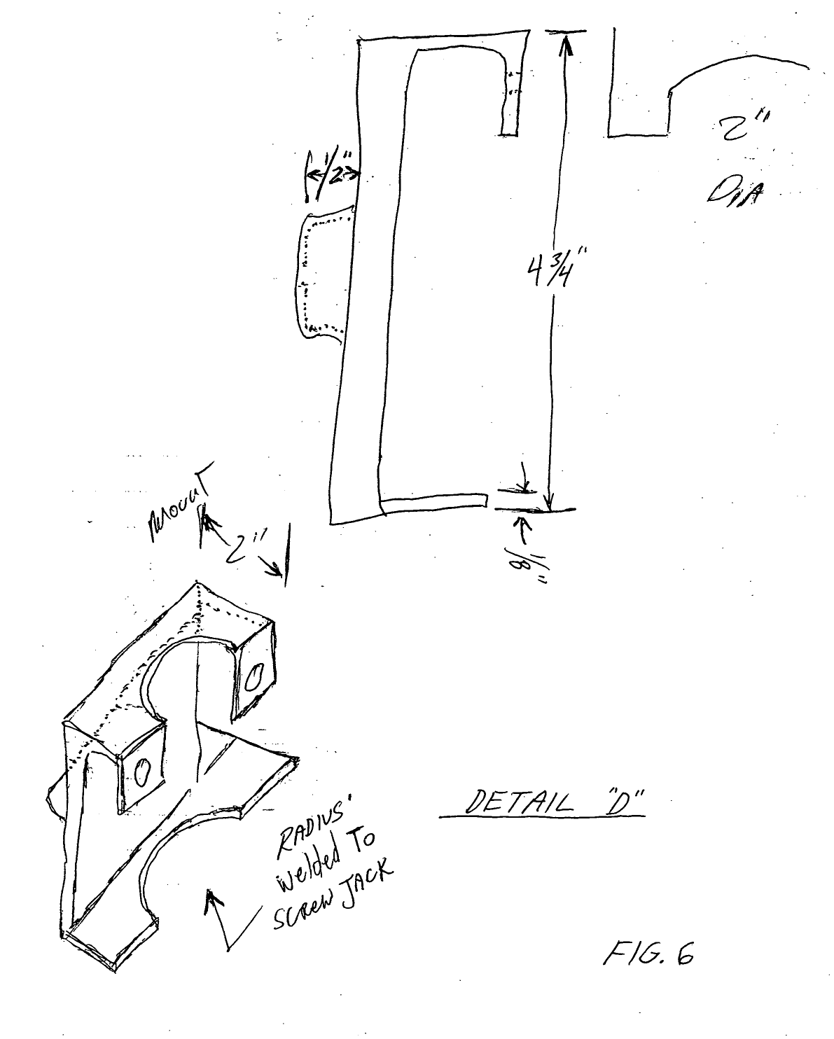

FIG. 6: Detail “D”, Sketch, for reference only, Welded Mount, Electric Screw Jack, (OEM mount only cut from, and welded to Electric Screw Jack), OEM: Fulton XP10, Performance Series Swing-Away 1000 lb. Capacity Hand Jack, Cequent Trailer products, Mosinee, Wisc. 54455.

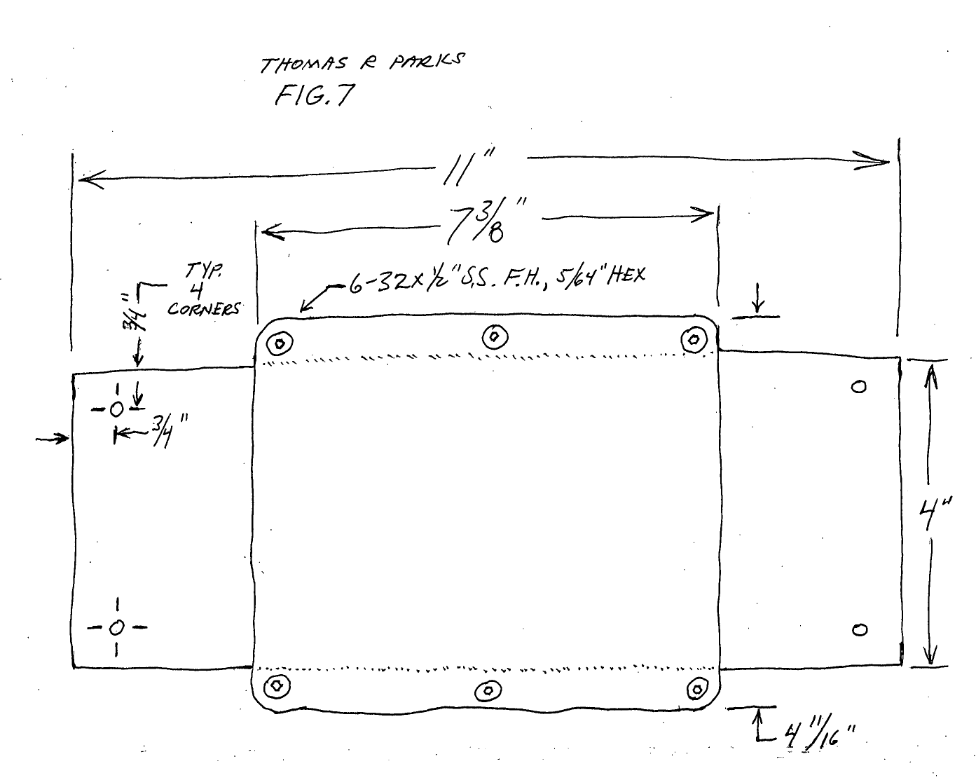

FIG. 7: Detail “E”, Sketch, for reference only, custom wired cast aluminum enclosure, attached to ¼″ thick aluminum mounting plate via thru-bolted #10-24×1½″ Stainless Steel flat head slotted machine screws, two per relay base within enclosure, (4 total screws, (see Bill of Material List)).

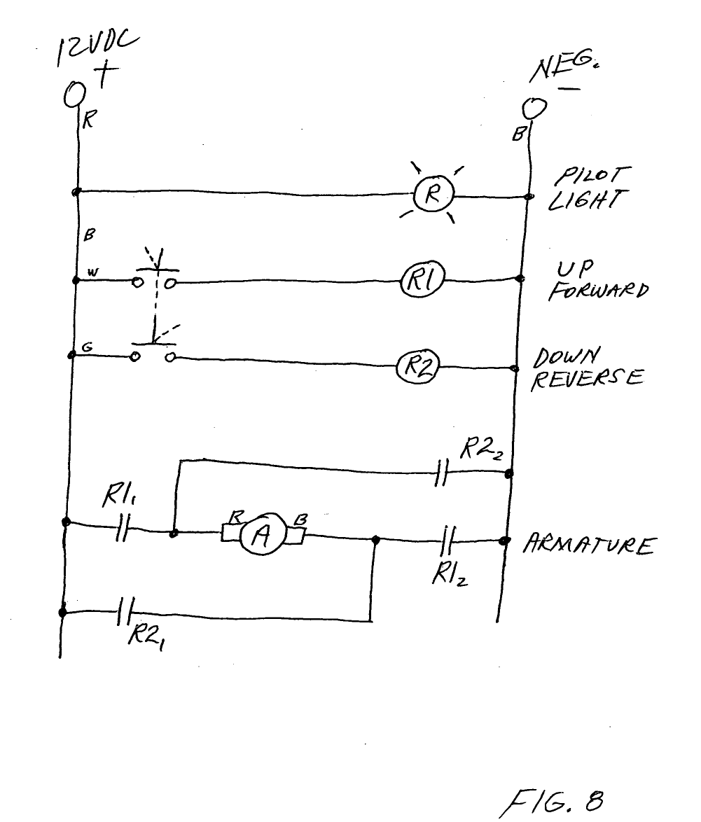

FIG. 8: Electrical Schematic Diagram Please note that the FIGS. One(1) thru Eight (8) drawings, sketches and diagram herein included in this Patent Application were drawn and submitted by Inventor as “Freehand”, without aid of any straightedge, squares, triangle, rule, templates, or any other drawing aids.

Please note also all Drawings and Sketches herein depicted and submitted in this Utility Patent Application No. 60/722,718. are by Inventor and are submitted as “Not To Scale”.

### BRIEF DESCRIPTION OF THE SEVERAL PHOTOGRAPHS OF THE INVENTION

Photo 1) Overall side view of the Invention including Remote Enclosure Screw jack, and partial conduit between them.

Photo 2) Overall Front view of Invention showing Remote Enclosure, Screw jack and partial conduit between same. This photo shows most of movable 3″ square tubing section on pivot section. Note that swing jack and wiring at center/bottom of portrait-format photograph is not included in this patent application.

Photo 3) Side view of Remote Enclosure, Screw Jack and partial conduit between them.

Photo 4) Close-Up side view of Remote Enclosure with cover on. Note all six cover screws installed.

Photo 5) Close up, side oblique view of Remote Enclosure, cover removed to show internal wired components.

Photo 6) Close up, front view of remote Enclosure, (cover on). Note Screw jack in background.

Photo 7) Rear oblique photo of screw jack, conduit, and Remote Enclosure. Note high temperature, glass cloth, wiring-outer sheathing on #8 AWG Screw jack wire conductors that transition through rubber grommets into Remote Enclosure. (Grommets not shown in photograph).

Photo 8) Close up side view of 12 Volt D.C. electric reversing Screw jack. Note welded foot at base of 3 Inch square movable tubing at bottom of photo.

Photo 9) Front view of hand-held plug-in umbilical pilot remote control.

Photo 10) Top view of hand held plug-in umbilical pilot remote control.

Photo 11) Front view of power harness NEMA plugs, #8 AWG, 2-conductor power connecting cord, 10-foot length.

Photo 12) Power harness, #8 AWG, with NEMA plugs, front and back plug views, close up (Note embossed UL rating and electrical rating on plug back plate).

### DETAILED DESCRIPTION OF THE INVENTION

1) Innovative, unique, compact and corrosion-resistant passive wired remote control enclosure for use to safely control raise and lower functions of this 12 Volt D.C. remote device and corresponding vertically mounted motor-driven reversing screw jack.The remote enclose and separately mounted screw jack described above is for use with any standard automotive or Recreational Vehicle-type pivot trailer tongue hitches.

2) The permanently mounted remote control enclosure, (with its entire wired internal contents), and associated separately-mounted screw jack affixed to the trailer herein described, are the two main items of equipment listed in this DETAILED DESCRIPTION.

3) Both power and separate handheld umbilical-type remote control wired connections unplug completely from the permanently mounted control enclosure, leaving the respective mating receptacles and control enclosure without any external energy source for safe stationary or stored passive status during travel.

4) Power is supplied via heavy Number 8 AWG, (American Wire Gauge), 2-wire, 30 ampere rated wired receptacle connector from the tow vehicle to the remotely mounted control enclosure mounted on the trailer that is hitched to the tow vehicle or while disconnected from the same. This same power source is represented by an obvious and permanently mounted red pilot light fixture on the remote control enclosure visually affirming the same when in use, or during stand-by status.

This deliberate power representation remains illuminated the entire time while connected to the tow vehicle, and also before, during, and after any desired raise and lower functions are commanded. This same power indication will extinguish upon subsequent disconnection of the power cord from the tow vehicle.

5) The screw jack and remote enclosure are permanently mounted to the trailer and are connected both by means via #8 AWG copper wire. The wire is routed through permanently mounted, polished and buffed stainless steel ¾ inch tubing and acts as a partial conduit between them.

6) The listed features and use of this device will greatly aid and assist any person needing assistance with heavy tongue-weight-laden, pivot-type trailer connections on level ground or especially where inclines are involved. This is extremely useful for clearing close overhead doorways along inclines during reverse or back-up mode operations.

7) This device and its features herein explained will aid anyone, especially handicapped or disabled persons requiring the same.

1. What I claim as my invention is a unique, electric remote enclosure that is custom wired for use with an already existing 12 Volt Direct Current, (D.C.) electric reversing screw jack, manufactured by others, (unknown, (TBD)).
I also claim the following in reference to Claim number ONE above, my enclosure, along with use with the reversing screw jack described, is my own idea, along with all the features wired within the custom enclosure, and all connections from without.

2. 1 claim my custom fabricated plug-in external power remote controls from without, as my own, and that they are incorporated in conjunction with my unique, custom wired enclosure aforementioned.
I hereby claim in reference to Claim number TWO above that I have not seen, used, or am aware of any device(s) similar to mine to exist that includes photographs, drawings, sketches, diagrams or any current operating device, in mind in me whatsoever, directly or indirectly, now or anytime in the past.

3. 1 hereby state that my invention consists of the combination of the following:
a) Custom fabricated remote enclosure, b) Plug-in power cord, c) Plug-in, hand held pilot device, and d) The towed trailer, permanently mounted electric reversing screw jack.
These four items aforementioned in Claim Number Three are what consists of my formal invention herein listed under this CLAIM.
